(19) United States
(12) Patent Application Publication
(10) Pub. No.: US 2022/0297603 A1
(43) Pub. Date: Sep. 22, 2022

(54) DIMMABLE REFLECTIVE DEVICE

(71) Applicant: Wicue, Inc., Cupertino, CA (US)

(72) Inventor: Fenghua LI, Cupertino, CA (US)

(21) Appl. No.: 17/655,073

(22) Filed: Mar. 16, 2022

Related U.S. Application Data
(60) Provisional application No. 63/162,325, filed on Mar. 17, 2021.

(51) Int. Cl. B60R 1/08; B60R 1/00; G02F 1/139; G02F 1/13363

(52) U.S. Cl. CPC B60R 1/088; B60R 1/006; G02F 1/1393; G02F 1/133638

(57) ABSTRACT

A layered structure comprises a transreflective layer configured to transmit light in a transmissive polarization orientation and reflect light in a reflective polarization orientation, at least one guest host (GH) liquid crystal layer comprising liquid crystal molecules and dichroic dye molecules and controllable to operate in at least a vertical state and a planar state. The layered structure is configured to transmit linearly polarized light. In a first reflection mode, the layered structure is configured to reflect light corresponding to a first reflectivity rate. In a second reflection mode, the layered structure is configured to reflect light corresponding to a second reflectivity rate less than the first reflectivity rate.

### BACKGROUND

### 1. Field of Disclosure

The present disclosure relates to the field of light reflection devices, and particularly relates to dimmable light reflection devices, such as an automotive interior rearview mirror device. In some embodiments, the device implements automatic adjustment of reflectivity according to a detected intensity of light, e.g., from the rear of a vehicle, and can effectively protect a driver of the vehicle from the interference of strong light from the rear of the vehicle.

### 2. Description of Related Art

Traditional dimmable automotive interior rearview mirror uses mat paper color change technology. When the interior rearview mirror light-sensitive components receive a certain intensity of light from the rear of the car, a driver module outputs a driving current to induce an electrochemical reaction in an electrochromic medium layer, which undergoes a color change from a transparent state to a dark state, thus adjusting the reflectivity of the rearview mirror. However, such electrochromic technology is generally complicated and associated with high cost. Also, low reflectivity is typically not low enough, and the response speed is slow, usually up to 6 seconds. Furthermore, strong light from the rear of the vehicle generally cannot be well blocked quickly, which can pose a safety hazard.

### BRIEF SUMMARY

The present disclosure provides a dimmable reflective device generally. In some embodiments, the present disclosure provides a dimmable mirror configured to be used in conjunction with a display device for display. For instance, the dimmable mirror may be used as an automotive interior rearview mirror device. The display may present streaming media such as a live video comprising images captured from a camera from an exterior of a vehicle. In some embodiments, such an automotive interior rearview mirror device or automotive sideview mirror device may include a dimming device, a streaming display, a light-sensitive driving system, etc. In some embodiments, the streaming display is replaced with a mirror. The dimming device may include one or more layers of liquid crystal layer and semi-translucent and semi-reflective film. When the light-sensitive element senses strong light from the rear of the vehicle, such as the strong light from another vehicle's high beam at night, the corresponding signal can be fed back to the driving system, and the driving system outputs the corresponding intensity of an electric field to drive the liquid crystal layer to realize the reflectivity adjustment of the rearview mirror. Such an arrangement may effectively protect the driver from the interference of the strong light from the rear of the vehicle and effectively improve the night driving safety.

When the content of the rearview mirror streaming display needs to be displayed, the dimming device can exhibit a high transmittance, effectively passing the light emitted from the display, making the image of the display highly transparent and clear display.

An example apparatus having a layered structure comprises a transreflective layer configured to transmit light in a transmissive polarization orientation and reflect light in a reflective polarization orientation. The apparatus further may comprise at least one guest host (GH) liquid crystal layer comprising non-cholesteric liquid crystal molecules having a non-helical structure and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer. The apparatus further may comprise a switchable quarter-wave layer positioned between the transreflective layer and the at least one GH liquid crystal layer, the switchable quarter-wave layer comprising an electronically controlled birefringence (ECB) retarder comprising liquid crystal molecules, wherein in a transmission mode, the layered structure is configured to transmit linearly polarized light originating from a first side of the layered structure through the layered structure to a second side of the layered structure, corresponding to a transmittance rate, wherein in a first reflection mode, the layered structure is configured to reflect light originating from the second side of the layered structure back toward the second side of the layered structure, corresponding to a first reflectivity rate, and wherein in a second reflection mode, the layered structure is configured to reflect light originating from the second side of the layered structure back toward the second side of the layered structure, corresponding to a second reflectivity rate less than the first reflectivity rate.

An example apparatus having a layered structure comprises a transreflective layer configured to transmit light in a transmissive polarization orientation and reflect light in a reflective polarization orientation. The apparatus further may comprise at least one guest host (GH) liquid crystal layer comprising liquid crystal molecules and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer, wherein in a transmission mode, the layered structure is configured to transmit linearly polarized light originating from a first side of the layered structure through the layered structure to a second side of the layered structure, corresponding to a transmittance rate, wherein in a first reflection mode, the layered structure is configured to reflect light originating from the second side of the layered structure back toward the second side of the layered structure, corresponding to a first reflectivity rate, and wherein in a second reflection mode, the layered structure is configured to reflect light originating from the second side of the layered structure back toward the second side of the layered structure, corresponding to a second reflectivity rate less than the first reflectivity rate.

An example apparatus having a layered structure comprises a reflective layer. The apparatus further may comprise at least one guest host (GH) liquid crystal layer comprising liquid crystal molecules and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer. The apparatus further may comprise a quarter-wave layer positioned between the reflective layer and the at least one GH liquid crystal layer, wherein in a first reflection mode, the layered structure is configured to reflect light originating from a first side of the layered structure back toward the first side of the layered structure, corresponding to a first reflectivity rate, and wherein in a second reflection mode, the layered structure is configured to reflect light originating from the first side of the layered structure back toward the first side of the layered structure, corresponding to a second reflectivity rate less than the first reflectivity rate.

An example apparatus having a layered structure comprises a reflective layer. The apparatus further may comprise a first guest host (GH) liquid crystal layer comprising liquid crystal molecules and dichroic dye molecules. The apparatus further may comprise a second GH liquid crystal layer positioned between the reflective layer and the first GH liquid crystal layer, the second GH liquid crystal layer comprising liquid crystal molecules and dichroic dye molecules, wherein each of the first and second GH liquid crystal layers is controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer, and wherein in a first reflection mode, the layered structure is configured to reflect light originating from a first side of the layered structure back toward the first side of the layered structure, corresponding to a first reflectivity rate, and wherein in a second reflection mode, the layered structure is configured to reflect light originating from the first side of the layered structure back toward the first side of the layered structure, corresponding to a second reflectivity rate less than the first reflectivity rate.

### BRIEF DESCRIPTION OF THE DRAWINGS

FIG. 1A shows one implementation of an interior rearview mirror assembly incorporating a dimmable mirror and an optional display device, according to some embodiments of the disclosure.

FIG. 1B shows one implementation of an exterior side mirror assembly incorporating a dimmable mirror and an optional display device, according to some embodiments of the disclosure.

FIG. 2A presents the structure of a single-layer cholesteric liquid crystal implementation of a dimmable mirror apparatus including a display, according to some embodiments of the disclosure.

FIG. 2B illustrates a display transmission mode of a dimmable mirror apparatus using a single-layer cholesteric liquid crystal comprising a single guest-host (GH) liquid crystal layer, according to some embodiments of the disclosure.

FIG. 2C illustrates a high reflection mode of the dimmable mirror apparatus using a single-layer cholesteric liquid crystal comprising a single guest-host (GH) liquid crystal layer, according to some embodiments of the disclosure.

FIG. 2D illustrates a low reflection mode of the dimmable mirror apparatus using a single-layer cholesteric liquid crystal comprising a single guest-host (GH) liquid crystal layer, according to some embodiments of the disclosure.

FIG. 3A presents the structure of a double-layer liquid crystal implementation of a dimmable mirror apparatus including a display and operating in a weak absorption state, according to some embodiments of the disclosure.

FIG. 3B presents the same structure of a double-layer liquid crystal implementation of a dimmable mirror apparatus including a display and operating in a strong absorption state, according to some embodiments of the disclosure.

FIG. 3C illustrates a display transmission mode of a dimmable mirror apparatus using a double-layer liquid crystal structure, according to some embodiments of the disclosure.

FIG. 3D illustrates a high reflection mode of the dimmable mirror apparatus using a double-layer liquid crystal structure, according to some embodiments of the disclosure.

FIG. 3E illustrates a low reflection mode of the dimmable mirror apparatus using a double-layer liquid crystal structure, according to some embodiments of the disclosure.

FIG. 4A illustrates a low reflection state of a single-layer non-cholesteric liquid crystal dimmable mirror device including a display, according to some embodiments of the disclosure.

FIG. 4B illustrates the operation of such a single-layer non-cholesteric liquid crystal dimmable mirror device including a display, according to some embodiments of the disclosure.

FIG. 5A illustrates a low reflection state of a single-layer non-cholesteric liquid crystal dimmable mirror device without a display, according to some embodiments of the disclosure.

FIG. 5B illustrates the operation of such a single-layer non-cholesteric liquid crystal dimmable mirror device without a display and a non-switchable quarter-wave plate, according to some embodiments of the disclosure.

FIG. 6A illustrates a high reflection state of a double-layer non-cholesteric liquid crystal dimmable mirror device without a display, according to some embodiments of the disclosure.

FIG. 6B illustrates a low reflection state of the double-layer non-cholesteric liquid crystal dimmable mirror device without a display, according to some embodiments of the disclosure.

FIG. 7 shows a drive circuitry system for providing driving signals for components of devices described previously.

### DETAILED DESCRIPTION

Embodiments of the present disclosure provide a dimmable mirror device (e.g., interior rearview mirror device), which can realize automatic adjustment of reflectivity according to the intensity of light (e.g., from the rear of the vehicle). Embodiments of the disclosure can, for example, effectively protect the driver from the interference of strong light from the rear of the vehicle. At the same time, the device can optionally be combined with display of content, such as media streaming achieved through high transmission and high-definition display of images, to enrich human-computer interaction.

According to various embodiments, an apparatus having a layered structure is disclosed. A transreflective layer is configured to transmit light in a transmissive polarization orientation and reflect light in a reflective polarization orientation. At least one guest host (GH) liquid crystal layer comprising liquid crystal molecules and dichroic dye molecules. Each of the at least one GH liquid crystal layer is controllable to operate in at least two possible states, including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer. In a transmission mode, the layered structure is configured to transmit linearly polarized light originating from a first side of the layered structure through the layered structure to a second side of the layered structure, corresponding to a transmittance rate. In a first reflection mode, the layered structure is configured to reflect light originating from the second side of the layered structure back toward the second side of the layered structure, corresponding to a first reflectivity rate. In a second reflection mode, the layered structure is configured to reflect light originating from the second side of the layered structure back toward the second side of the layered structure, corresponding to a second reflectivity rate less than the first reflectivity rate.

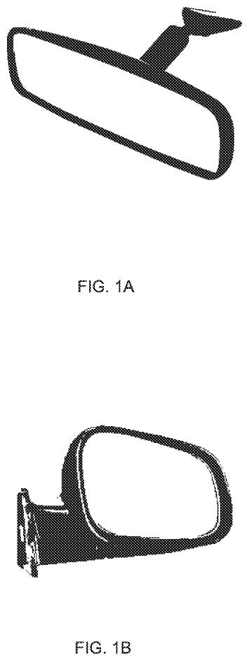

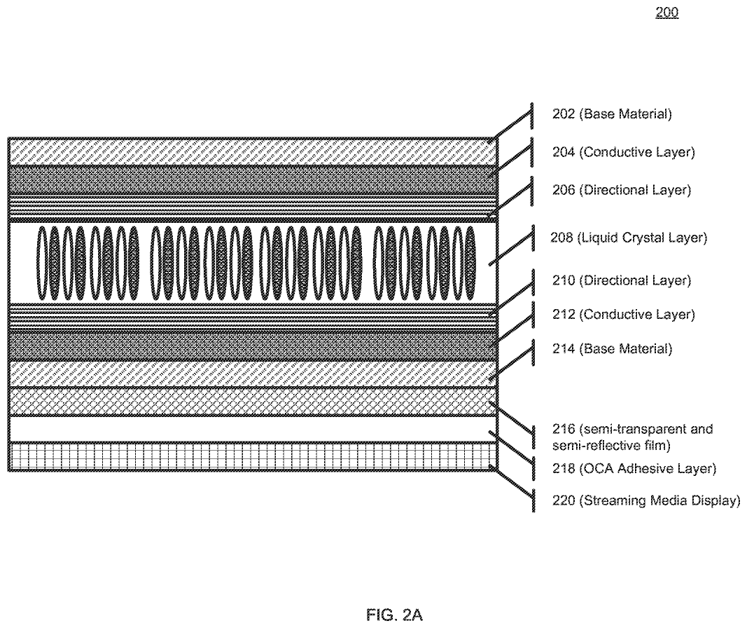

The present disclosure proposes mirror device comprising a plurality of solutions as follows. The mirror device may include a display in some embodiments and may include no display in other embodiments. The mirror device may be used in a vehicular application and may be implemented in an interior and/or exterior region of a vehicle. For example, embodiments of the mirror device may be implemented as an interior rearview mirror and/or an exterior side mirror for a vehicle. FIG. 1A shows one implementation of an interior rearview mirror assembly incorporating a dimmable mirror and an optional display device, according to some embodiments of the disclosure. FIG. 1B shows one implementation of an exterior side mirror assembly incorporating a dimmable mirror and an optional display device, according to some embodiments of the disclosure.

I. Single Layer Cholesteric LC

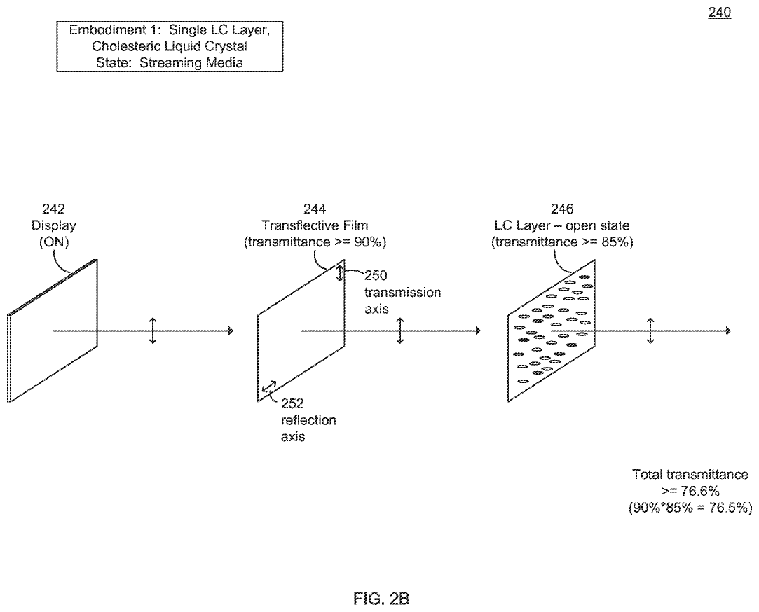

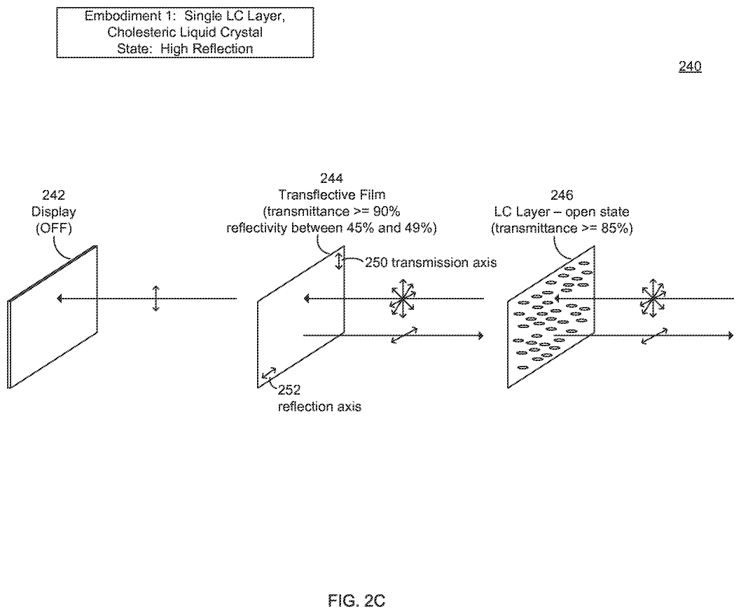

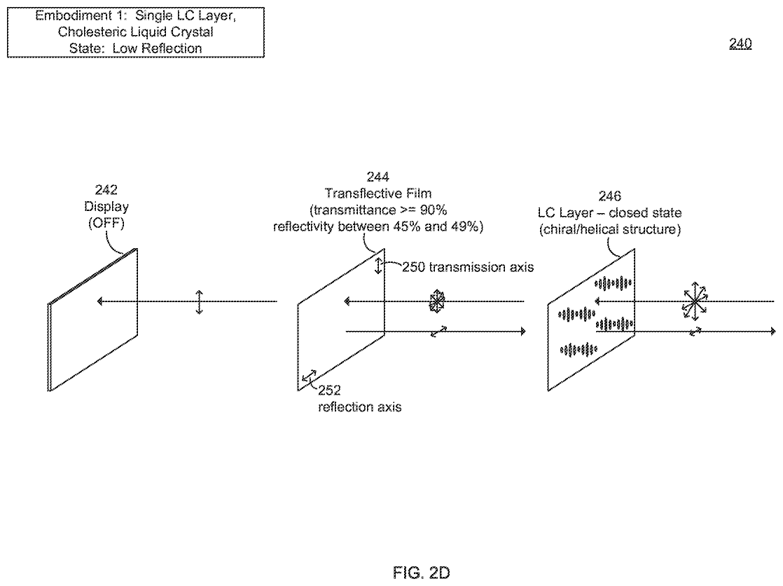

FIG. 2A presents the structure of a single-layer cholesteric liquid crystal implementation of a dimmable mirror apparatus 200 including a display, according to some embodiments of the disclosure. As used herein, a display or display device may comprise a display panel capable of emitting light from a plurality (e.g., matrix) of pixels or sub-pixels. For example, the single-layer cholesteric LC may be a single guest-host (GH) liquid crystal layer. The single GH liquid crystal layer may comprise cholesteric liquid crystal molecules. Here, the term cholesteric refers to liquid crystal molecules characterized by a helical structure. The helical structure of cholesteric liquid crystals can be achieved with chiral liquid crystal molecules. Alternatively, the helical structure of cholesteric liquid crystals can be achieved with achiral liquid crystal molecules doped with a chiral dopant. As shown in FIG. 2A, a single-layer dichroic dye liquid crystal dimming stack is combined with a transreflective film and a streaming media display. The structure comprises:
A first base (substrate) material layer 202
A first conductive layer 204
A first directional layer 206
A liquid crystal (LC) layer 208
A second directional layer 210
A second conductive layer 212
A second base (substrate) material layer 214
A transreflective film layer 216
An OCA adhesive layer 218
A display layer 220

The first directional layer 206 and the second directional layer 210 are arranged on opposite sides of and sandwich the liquid crystal (LC) layer 208. Each of the directional layers 206 and 210 is characterized by a surface having grooves along a certain direction. Such grooves (e.g., ridges and troughs) may be formed by rubbing a base material, such as a polyimide, with another material, such as a cotton ball or cloth, along a certain direction. Liquid crystal molecules coming into contact with the directional layers 206 and 210 tend to align, or anchor, themselves with their longitudinal axes in parallel to the grooves. The strength of such alignment is associate with a characteristic anchoring energy, which may be as high as 10⁻³ Joules/meter², for example. The first conductive layer 204 and the second conductive layer 212 are arranged on opposing sides of and sandwich the liquid crystal layer 208, the first directional layer 206, and the second directional layer 210. A voltage applied across the first conductive layer 204 and the second conductive layer 212 generates an electrical field that impacts the orientation of the liquid crystal molecules within the liquid crystal layer 208. Different liquid crystal orientations may be achieved by operation of the applied voltage. In one embodiment, when no voltage is applied, the liquid crystal molecules are naturally in a cholesteric phase and exhibit a chiral/helical orientation. That is, the liquid crystal molecules twist, for example, with a particular chiral pitch, p. When a voltage (e.g., beyond a certain threshold) is applied the liquid crystals may become orientated based on the electrical field generated by the first conductive layer 204 and the second conductive layer 212. For example, the electric field may cause the liquid crystal molecules to align such that their long axes are perpendicular to the plane of the liquid crystal layer 208.

The first base (substrate) material layer 202 and the second base (substrate) material layer 214 are arranged on opposite sides of and sandwich the liquid crystal (LC) layer 208, the first directional layer 206, the second directional layer 210, the first conductive layer 204, and the second conductive layer 212. In some embodiments, the first base (substrate) material layer 202 and the second base (substrate) material layer 214 provide mechanical stability to the various layers mentioned above. A stacked structure comprising these layers—e.g., the liquid crystal (LC) layer 208, the first directional layer 206, the second directional layer 210, the first conductive layer 204, the second conductive layer 212, the first base (substrate) material layer 202, and the second base (substrate) material layer 214—may be manufactured as a flexible, multi-layered liquid crystal “film” which may be attached to the semi-transmissive and semi-reflective (“transreflective”) film 216. An example of the transreflective film 216 a 3M dBEF semi-transparent, semi-transmissive film. The transreflective film 216 may be attached to the display device 220. Attachment of the various layers mentioned above to each other and/or other layers may be achieved by using one or more adhesive layer(s), such as the OCA adhesive layer 218.

While multiple layers of materials are described herein, the overall dimmable mirror apparatus 200 is nevertheless described as having as a “single-layer” cholesteric liquid crystal. This is because only a single LC layer is present in this particular embodiment of the disclosure. In other embodiments, described in subsequent sections of the disclosure, liquid crystal molecules may reside in two or more LC layers, which may work in conjunction with one another to effectuate the dimming and/or display transmission operations of the overall apparatus. Also, note that FIG. 2A illustrates two base (substrate) layers 202 and 214, two conductive layers 204 and 212, two directional layers 206 and 210, an OCA adhesive layer 218, in addition to the liquid crystal layer 208, transreflective layer 216, and streaming media display 220. In other figures of the present disclosure, some of these layers, such as base (substrate) layers, conductive layers, directional layers, OCA adhesive layers, etc. are not explicitly shown in order to simplify illustration. However, it should be understood that some of these layers may be included in the various embodiments shown in other figures, even if such layers may not be explicitly shown in those figures. Various layers may be added or omitted in different embodiments and depending on implementation.

A. Transmission Mode (e.g., FIG. 2B)

FIG. 2B illustrates a display transmission mode of a dimmable mirror apparatus 240 using a single-layer cholesteric liquid crystal comprising a single guest-host (GH) liquid crystal layer, according to some embodiments of the disclosure. The dimmable mirror apparatus 240 may be an example of the dimmable mirror apparatus 200 shown in FIG. 2A. Here, the dimmable mirror apparatus 240 comprises a display 242, a transreflective film 244 (e.g., 3M dBEF semi-transparent, semi-trans film), and a single-layer cholesteric liquid crystal 246, which may comprise a single GH liquid crystal layer. In this figure, only certain layers are shown to illustrate the primary operations of the transmission mode. Additional layers not explicitly shown may nevertheless be included, such as various conductive layer(s), directional layer(s), base (substrate) layers, adhesive layer(s), etc.

During the display transmission mode, the display 242 (e.g., streaming media display) may emit display light in the form of linearly polarized light. The polarization direction of the linearly polarized light may be parallel to the transmission direction/axis 250 of the transreflective film 244. As an example, the transmission direction/axis 250 of the transreflective film 244 may be in a vertical direction. By contrast, the reflection direction/axis 252 of the transreflective film 244 may be in a horizontal direction. Because the polarization direction of the linearly polarized light is in the vertical direction, the linearly polarized light mostly transmits through the transreflective film 244. For example, the light transmission rate of the linearly polarized light through the transreflective film 244 may be ≥90%.

The linearly polarized light may transmit through both the transreflective film 244 and the liquid crystal layer 246. Here, the liquid crystal layer 246 is in the open state. The long axis of the dichroic dye liquid crystal molecules within the liquid crystal layer 246 is perpendicular to the plane of the substrate. This may be achieved, for example, by applying an appropriate voltage across conductor layers (not shown) that sandwich the liquid crystal layer 246. At this time, the light transmitted through the liquid crystal layer experiences weak absorption. For example, the liquid crystal layer transmittance rate may be ≥85%. The light emitted by the streaming media display 242 may experience, through the entire layered structure, a total transmittance rate of ≥76.5%. This may correspond to a relatively high brightness of the display. Such transmittance achieves high transmission and high definition of the display.

In some embodiments, if a strong light is directed toward the device from the user side during streaming media mode, the LC layer is kept in the “open” state (state in which the liquid crystal molecules are oriented in a direction perpendicular to the plane of the LC layer), to allow display light to continue to project toward the user. Here, a light-sensitive element such as a light sensor (not shown) may be incorporated to sense light (e.g., ambient light) originating from user side (i.e., right side of FIG. 2B) and traveling toward the dimmable mirror apparatus 240. Even though the light sensor senses a strong light, the LC layer may be kept in the “open” state if the device is in the streaming media state. This allows the streaming media from the display to continue to be presented to the user, even while bright light is detected. Thus, when in the streaming media mode, the display may appear dark, even while a bright light is detected.

B. Reflection Modes (e.g., FIGS. 2C and 2D)

During one or more reflection modes, the streaming display 242 is turned off, forming a black background, according to various embodiments of the disclosure. There may also exist more than one reflection mode, such as a high reflection mode and a low reflection mode, described in more detail below.

FIG. 2C illustrates a high reflection mode of the dimmable mirror apparatus 240 using a single-layer cholesteric liquid crystal comprising a single guest-host (GH) liquid crystal layer, according to some embodiments of the disclosure. As described previously, the dimmable mirror apparatus 240 may comprise a display 242, a transreflective film 244 (e.g., 3M dBEF semi-transparent, semi-trans film), and a single-layer cholesteric liquid crystal, which may comprise a single GH liquid crystal layer 246. At this time, the long axis of dichroic dye liquid crystal molecules within the liquid crystal layer 246 is perpendicular to the plane of the substrate, and unpolarized light originating from the user side (i.e., right side of FIG. 2C) passing through the liquid crystal layer 246 experiences weak absorption. Here, the transmittance rate of the liquid crystal layer 246 may be, for example, ≥85%. The resulting nonpolarized light, after weak absorption, reaches the transreflective film 244, which partially transmits and partially reflects the light. As shown here and as discussed previously, the transmission direction/axis 250 of the transreflective film 244 may be in a vertical direction. The reflection direction/axis 252 of the transreflective film 244 may be in a horizontal direction. Thus, vertically polarized light traverses the transreflective film 244, while horizontally polarized light reflects off of the transreflective film 244. The transmission and reflectivity rates generally depend on the properties of the transreflective film. In some embodiments, reflectivity can be between 45% and 49.9%, making the rearview mirror highly reflective. For example, such high reflection may allow a driver of a vehicle to clearly see an image of the scene behind the vehicle.

FIG. 2D illustrates a low reflection mode of the dimmable mirror apparatus 240 using a single-layer cholesteric liquid crystal comprising a single guest-host (GH) liquid crystal layer, according to some embodiments of the disclosure. For example, when there is strong light behind the vehicle, a light intensity sensor (not shown) may signal feedback to the driver circuit (not shown). The driver circuit may rapidly respond by generating an appropriate voltage across conductor layers (not shown) that sandwich the liquid crystal layer 246, to turn the liquid crystals to a closed state. Here, the close state is implemented by providing an appropriate voltage to orient the long axis of the dichroic dye liquid crystal molecules within the liquid crystal layer 246 to be parallel to the plane of the substrate. In some embodiments, to achieve this orientation parallel to the plane of the substrate, cholesteric liquid crystal molecules are placed into a chiral nematic phase. Specifically, the liquid crystal molecules become parallel to the plane of the liquid crystal layer and oriented in a helical pattern. This pattern results in significant absorption of light that is incident on the liquid crystal layer (e.g., strong light coming from the rear of the vehicle). Thus, in the low reflection state, light may be significantly absorbed. In one embodiment, approximately (1) 80% of the light is absorbed at the 1^{st} pass through LC layer 246, and approximately (2) 80% of the light is absorbed at 2^{nd} pass through the LC layer 246. The corresponding transmission rate along the entire reflection path is approximately 0.2*0.2=0.04. Thus, the total reflectivity in this example would be approximately 4%. In various embodiments, the total reflectivity rate may be, for example, <=8%, which can effectively reduce eye irritation from “rear glare” associated with light from behind the vehicle. Due to the naturally fast response characteristics of liquid crystal, the response time can reach ≤100 ms and can be ≤50 ms in some implementations. Such response speed is significantly faster than traditional electrochromic technology and can provide significantly quicker protection for a driver's eyes in a rear glare situation.

II. Double Layer LC

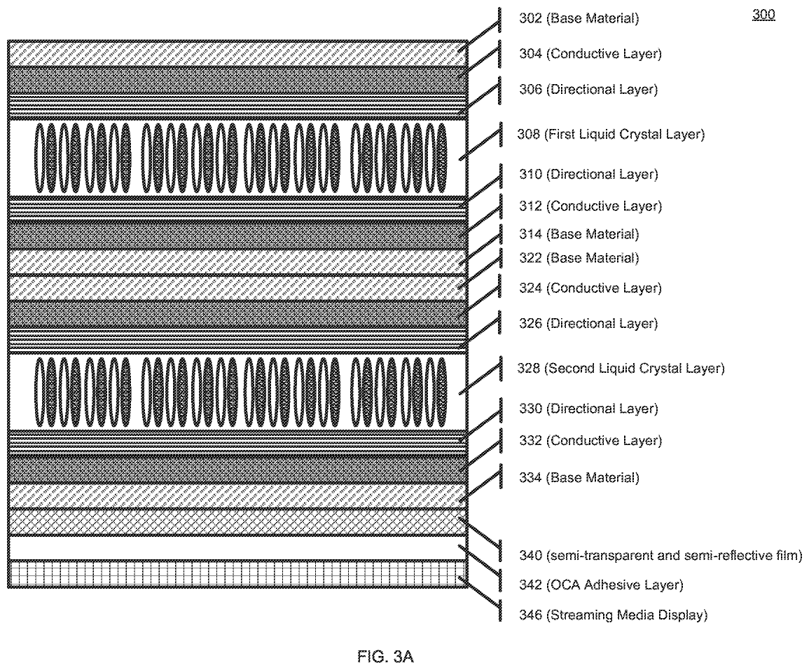

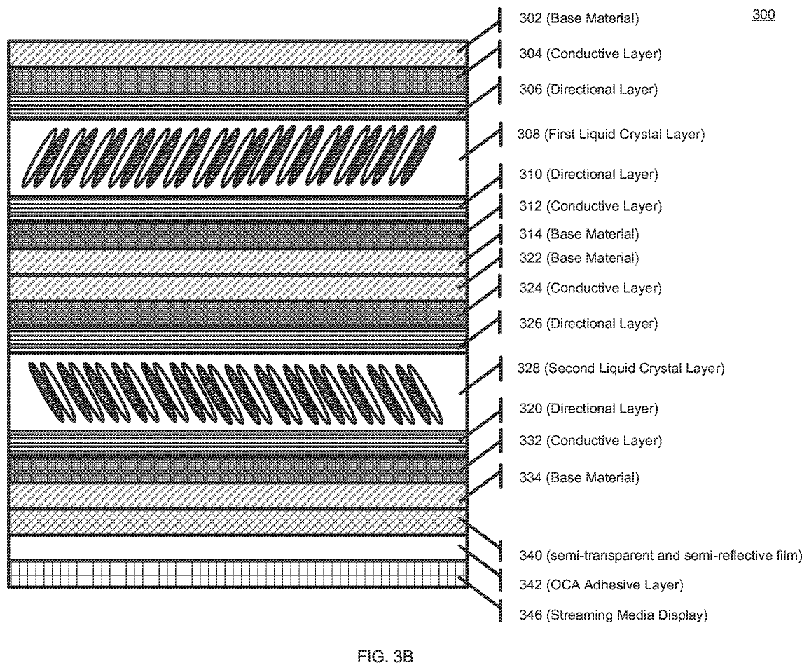

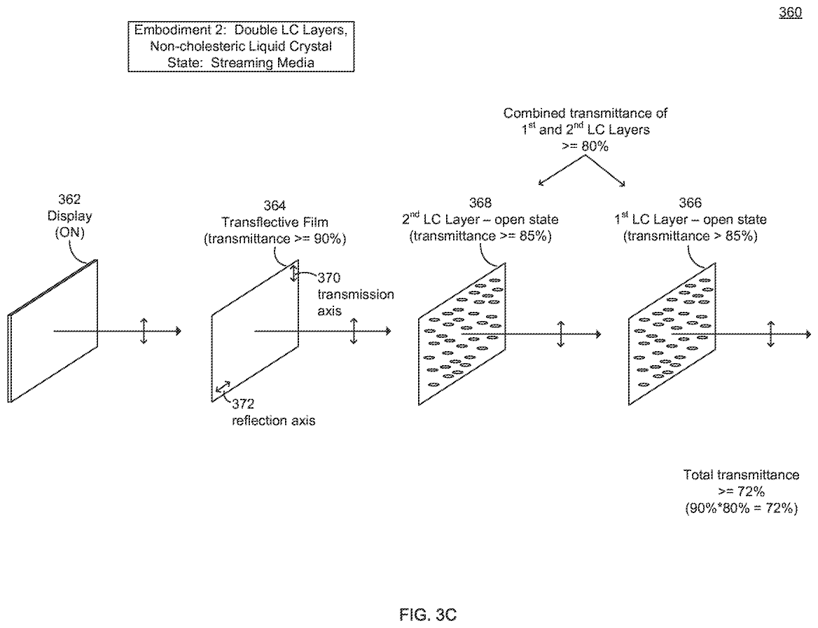

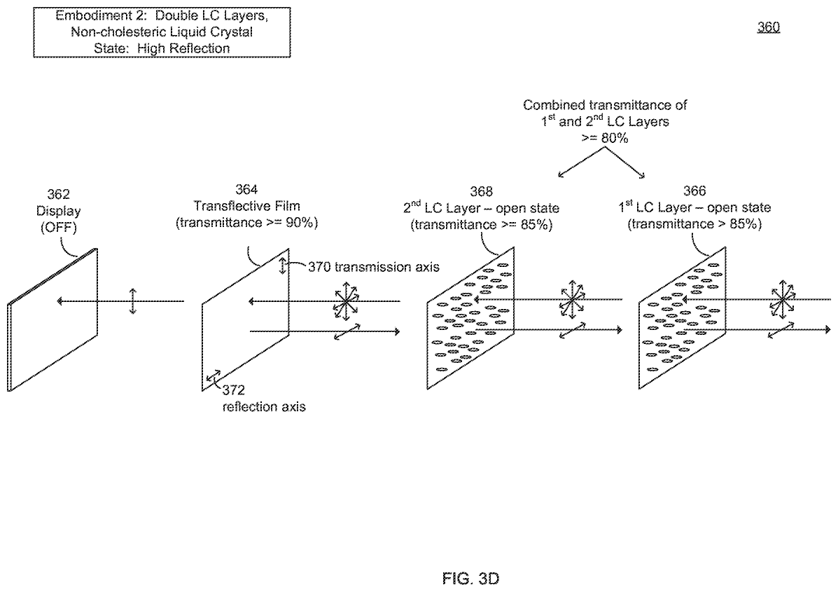

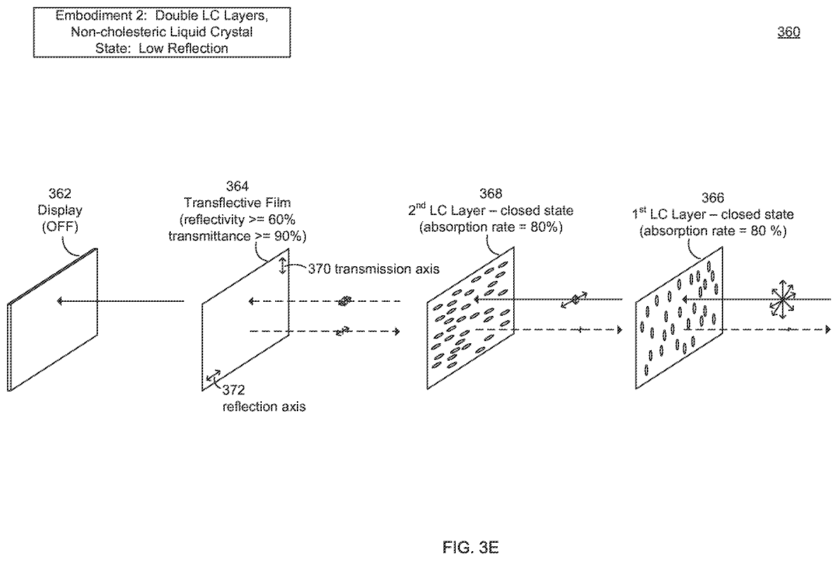

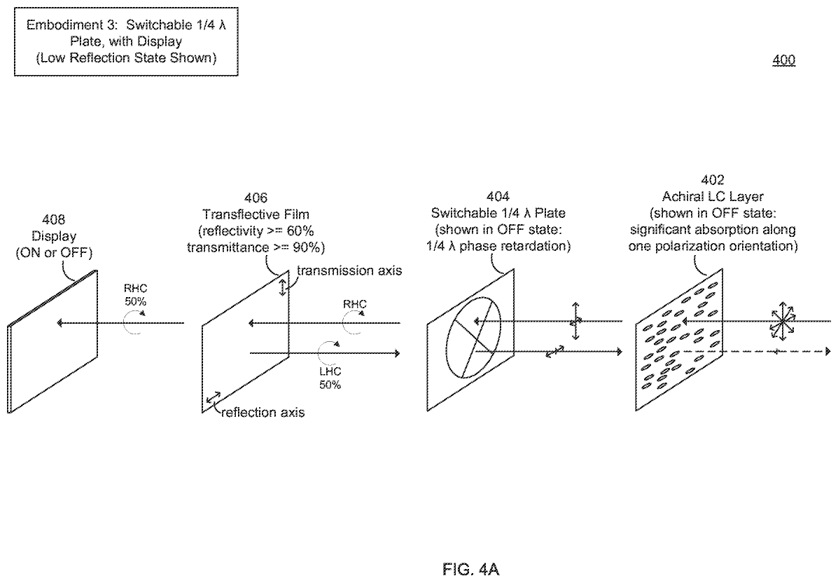

FIG. 3A presents the structure of a double-layer liquid crystal implementation of a dimmable mirror apparatus 300 including a display and operating in a weak absorption state, according to some embodiments of the disclosure. FIG. 3B presents the same structure of a double-layer liquid crystal implementation of a dimmable mirror apparatus 300 including a display and operating in a strong absorption state, according to some embodiments of the disclosure. An example of the stacked structure shown in FIGS. 3A and 3B comprises at least one guest-host (GH) liquid crystal layer, which include a first GH liquid crystal layer and a second GH liquid crystal layer. Each of the first GH liquid crystal layer and the second GH liquid crystal layer may comprise non-cholesteric liquid crystal molecules. The apparatus may also be referred to as a combination of double dichroic dye LC dimming layers, a transreflective film, and a streaming display. As shown in the figure, the structure comprises:
A first base (substrate) material layer 302
A first conductive layer 304
A first directional layer 306
A first liquid crystal (LC) layer 308
A second directional layer 310
A second conductive layer 312
A second base (substrate) material layer 314
A third base (substrate) material layer 322
A third conductive layer 324
A third directional layer 326
A second liquid crystal (LC) layer 328
A fourth directional layer 330
A fourth conductive layer 332
A fourth base (substrate) material layer 334
A transreflective film layer 340
An OCA adhesive layer 342
A display layer 344

In many respects, operation of a first portion of the structure comprising the first base (substrate) material layer 302, first conductive layer 304, first directional layer 306, first liquid crystal (LC) layer 308, second directional layer 310, second conductive layer 312, and second base (substrate) material layer 314 may be similar to that of certain layers shown in FIG. 2A—i.e., the first base (substrate) material layer 202, first conductive layer 204, first directional layer 206, liquid crystal (LC) layer 208, second directional layer 210, second conductive layer 212, and second base (substrate) material layer 214. For example, the first directional layer 306 and the second directional layer 310 are arranged on opposite sides of and sandwich the first liquid crystal (LC) layer 308. Each of the directional layers 306 and 310 is characterized by a surface having grooves along a certain direction. Liquid crystal molecules coming into contact with the directional layers 306 and 310 tend to align, or anchor, themselves with their longitudinal axes in parallel to the grooves. The first conductive layer 304 and the second conductive layer 312 are arranged on opposing sides of and sandwich the liquid crystal layer 308, the first directional layer 306, and the second directional layer 310. A voltage applied across the first conductive layer 304 and the second conductive layer 312 generates an electrical field that impacts the orientation of the liquid crystal molecules within the first liquid crystal layer 308. For example, the electric field may cause the liquid crystal molecules to align such that their long axes are perpendicular to the plane of the first liquid crystal layer 308, as shown in FIG. 3A.

Similarly, operation of a second portion of the structure comprising the third base (substrate) material layer 322, third conductive layer 324, third directional layer 326, second liquid crystal (LC) layer 328, fourth directional layer 330, fourth conductive layer 332, and fourth base (substrate) material layer 334 may be akin in many respects to that of certain layers shown in FIG. 2A—i.e., the first base (substrate) material layer 202, first conductive layer 204, first directional layer 206, liquid crystal (LC) layer 208, second directional layer 210, second conductive layer 212, and second base (substrate) material layer 214. The third directional layer 326 and the second directional layer 330 provide grooves along which liquid crystal molecules within the second liquid crystal layer 328 align. When an appropriate voltage is applied, the third conductive layer 324 and fourth conductive layer 332 may generate an electrical field that impacts the orientation of the liquid crystal molecules within the second liquid crystal layer 328. For example, the electric field may cause the liquid crystal molecules to align such that their long axes are perpendicular to the plane of the second liquid crystal layer 328, as shown in FIG. 3A.

Furthermore, operation of a third portion of the structure comprising the transreflective film layer 340, OCA adhesive layer 342, and display layer 344 may be similar in many respects to that of certain layers shown in FIG. 2A—i.e., the transreflective film layer 216, OCA adhesive layer 218, and display layer 220.

Under some conditions (e.g., when a voltage is applied), the liquid crystals may be placed in an open state and become orientated such that their long axes are perpendicular to the plane of the first liquid crystal layer 308, as shown in FIG. 3A. Under other conditions (e.g., when no voltage is applied), the liquid crystals may be placed in a nematic phase, in which the long axes of the liquid crystal molecules are parallel to the plane of the liquid crystal layers, as shown in FIG. 3B. In the nematic state, the liquid crystal molecules of the first liquid crystal layer 308 may have an orientation that is different from (e.g., perpendicular to) that of the liquid crystal molecules of the second liquid crystal layer 328. Such an arrangement may facilitate strong absorption of light and be useful in implementing a low reflection mode for the dimmable mirror apparatus, as discussed in more detail in later sections.

FIGS. 3A and 3B illustrates certain layers in a stacked structure. In other figures of the present disclosure, some of these layers, such as base (substrate) layers, conductive layers, directional layers, OCA adhesive layers, etc. are not explicitly shown in order to simplify illustration. However, it should be understood that some of these layers may be included in the various embodiments shown in other figures, even if such layers may not be explicitly shown in those figures. Various layers may be added or omitted in different embodiments and depending on implementation.

A. Transmission Mode (e.g., FIG. 3C)

FIG. 3C illustrates a display transmission mode of a dimmable mirror apparatus 360 using a double-layer liquid crystal structure, according to some embodiments of the disclosure. The dimmable mirror apparatus 360 may be an example of the dimmable mirror apparatus 300 shown in FIG. 3A. Here, the dimmable mirror apparatus 360 comprises a display 362, a transreflective film 364 (e.g., 3M dBEF semi-transparent, semi-trans film), first liquid crystal layer 366, and a second liquid crystal layer 368. According to certain embodiments, the first liquid crystal layer 366 and the second liquid crystal layer 368 comprise non-cholesteric liquid crystal molecules operable to be placed into a nematic state. In this figure, only certain layers are shown to illustrate the primary operations of the transmission mode. Additional layers not explicitly shown may nevertheless be included, such as various conductive layer(s), directional layer(s), base (substrate) layers, adhesive layer(s), etc.

During the display transmission mode, the display 362 (e.g., streaming media display) may emit display light in the form of linearly polarized light. The polarization direction of the linearly polarized light may be parallel to the transmission direction/axis 370 of the transreflective film 364. As an example, the transmission direction/axis 370 of the transreflective film 364 may be in a vertical direction. By contrast, the reflection direction/axis 372 of the transreflective film 364 may be in a horizontal direction. Because the polarization direction of the linearly polarized light is in the vertical direction, the linearly polarized light mostly transmits through the transreflective film 364. For example, the light transmission rate of the linearly polarized light through the transreflective film 364 may be ≥90%.

The linearly polarized light may transmit through both the transreflective film 364, the first liquid crystal layer 366, and the second liquid crystal layer 368. Here, the first liquid crystal layer 366 and the second liquid crystal layer 368 are both in the open state. The long axis of the dichroic dye liquid crystal molecules within the first liquid crystal layer 366 and second liquid crystal layer 368 is perpendicular to the plane of the substrate. This may be achieved, for example, by applying an appropriate voltage across conductor layers (not shown) that sandwich each of the first liquid crystal layer 366 and the second liquid crystal layer 368. At this time, the light transmitted through the liquid crystal layers experiences weak absorption. For example, the combined liquid crystal layer transmittance rate for both LC layers may be ≥80%, which is slightly lower than that of the single-layer LC structure shown in FIG. 2B. The light emitted by the streaming media display may experience, through the entire multi-layer structure, a total transmittance rate of ≥72%. This may correspond to relatively high brightness of the display. Such transmittance achieves high transmission and high definition of the display.

In some embodiments, if a strong light is directed toward the device from the user side during streaming media mode, the first and second LC layers are kept in the “open” state (state in which the liquid crystal molecules are oriented in a direction perpendicular to the plane of the LC layer), to allow display light to continue to project toward the user. Here, a light sensor (not shown) may be incorporated to sense light (e.g., ambient light) originating from user side (i.e., right side of FIG. 3C) and traveling toward the dimmable mirror apparatus 360. Even though the light sensor senses a strong light, the first and second LC layers may be kept in the “open” state if the device is in the streaming media state. This allows the streaming media from the display to continue to be presented to the user, even while bright light is detected. Thus, when in the streaming media mode, the display may appear dark, even while a bright light is detected

B. Reflection Modes (e.g., FIGS. 3D and 3E)

During one or more reflection modes, the streaming display 362 is turned off, forming a black background, according to various embodiments of the disclosure. There may also exist more than one reflection mode, such as a high reflection mode and a low reflection mode, described in more detail below.

FIG. 3D illustrates a high reflection mode of the dimmable mirror apparatus 360 using a double-layer liquid crystal structure, according to some embodiments of the disclosure. As described previously, the dimmable mirror apparatus 360 may comprise a display 362, a transreflective film 364 (e.g., 3M dBEF semi-transparent, semi-trans film), a first LC layer 366, and a second LC layer 368. At this time, the long axis of dichroic dye liquid crystal molecules within the first LC layer 366 and a second LC layer 368 is perpendicular to the plane of the substrate, and unpolarized light originating from the user side (i.e., right side of FIG. 3D) passing through the first LC layer 366 and a second LC layer 368 experiences weak absorption. Here, the transmittance rate of the liquid crystal layers 366 and 368 may be, for example, ≥80% (e.g., ≥85%). The resulting nonpolarized light, after weak absorption, reaches the transreflective film 364, which partially transmits and partially reflects the light. As shown here and as discussed previously, the transmission direction/axis 370 of the transreflective film 364 may be in a vertical direction. The reflection direction/axis 372 of the transreflective film 364 may be in a horizontal direction. Thus, vertically polarized light traverses the transreflective film 364, while horizontally polarized light reflects off of the transreflective film 364. The transmission and reflectivity rates generally depend on the properties of the transreflective film. In some embodiments, reflectivity can be between 45% and 49.9%. In some embodiments, reflectivity can be ≥50%. In various embodiments, high levels of reflection achieved may allow a driver of a vehicle to clearly see an image of the scene behind the vehicle.

FIG. 3E illustrates a low reflection mode of the dimmable mirror apparatus 360 using a double-layer liquid crystal structure, according to some embodiments of the disclosure. For example, when there is strong light behind the vehicle, a light intensity sensor (not shown) may signal feedback to the driver circuit (not shown). The driver circuit may rapidly respond by generating an appropriate voltage across conductor layers (not shown) that sandwich the first liquid crystal layer 366 and the second liquid crystal layer 368. According to some embodiments, in this low reflection mode, the non-cholesteric liquid crystal molecules of the first liquid crystal layer 366 and the second liquid crystal layer 368 are driven to a nematic phase, in which the long axes of the liquid crystal molecules are parallel to the plane of the liquid crystal layers. Within the plane of the liquid crystal layers, the first liquid crystal layer 366 liquid crystal molecules arrangement direction and the second liquid crystal layer 368 liquid crystal molecules arrangement direction are perpendicular to each other. Here, the light transmission rate is lower than the low reflection mode corresponding to FIG. 2D. In certain embodiments, the light through the liquid crystal layers is linearly polarized light. The polarization direction of the linearly polarized light is perpendicular to the long axis of the liquid crystal molecules of the second liquid crystal layer. In at least one embodiment, only the relative linear polarization orientations/directions of the two LC layers are important. The polarization direction of the linearly polarized light through the liquid crystal layer is perpendicular to the light transmission axis of 3M semi-permeable semi-transmissive film, at which time the light is strongly absorbed by the semi-permeable semi-transmissive film, showing a lower reflectivity, at which time the reflectivity can reach ≤5% (total reflection path), lower than program one, more effectively reduce the rear of the car glare on eye irritation.

For example, light traveling from the rear of the vehicle (e.g., from the right side of FIG. 3E) may be unpolarized light. In the low reflection mode, the liquid crystal molecules of the first liquid crystal layer 366 have been driven such that their long axes are parallel to the plane of the first liquid crystal layer 366 and vertical within the plane of the first liquid crystal layer 366. The vertically oriented liquid crystal molecules significantly absorb vertically polarized (linearly polarized in the vertical orientation) light. The resulting light is thus mostly horizontally polarized (linearly polarized in the horizontal orientation). In other words, the linear polarization orientation of the resulting light is horizontal in this case. Because absorption of the vertically polarized light is not perfect, there is residual vertically polarized light as well. The resulting light then passes through the second liquid crystal layer 368. In the low reflection mode, the liquid crystal molecules of the second liquid crystal layer 368 have been driven such that their long axes are parallel to the plane of the second liquid crystal layer 368 and horizontal within the plane of the second liquid crystal layer 368. The horizontally oriented liquid crystal molecules significantly absorb horizontally polarized (linearly polarized in the horizontal orientation) light. The resulting light, which now has passed through both the first and the second liquid crystal layers, is significantly attenuated in both the vertical polarization orientation and the horizontal polarization orientation. Because absorption of the horizontally polarized light is not perfect, there is also residual horizontally polarized light. The light that pass through both the first and the second liquid crystal layers now encounters the transreflective film. In this example, the transreflective firm 364 has a transmission axis that is vertically oriented. Thus, the residual vertically polarized light transmits through the transreflective film. The reflected light now comprises mostly horizontally polarized light. The residual horizontally polarized light is reflected by the transreflective film 364. On the reflection path (return path), the light now passes through the second liquid crystal layer 368 again (in the reverse direction). The horizontally oriented liquid crystal molecules further absorb the already-attenuated horizontally polarized light in the reflected light. The resulting light then passes through the first liquid crystal layer 366 again (in the reverse direction). The vertically oriented liquid crystal molecules of the first liquid crystal layer 366 further absorb much of the remaining vertically oriented polarized light in the reflected light. The resulting light then travels, as the final reflected light, toward the rear of the vehicle (toward the right side of FIG. 3E) in this example. Regarding the embodiment shown in FIG. 3E, its high reflectivity is slightly lower than that of the embodiment shown in FIG. 2D, but its low reflectivity is lower than that of the embodiment shown in FIG. 2D and may be more effective in reducing the eye irritation caused by rear glare from behind the vehicle.

III. Single Layer Non-Cholesteric LC

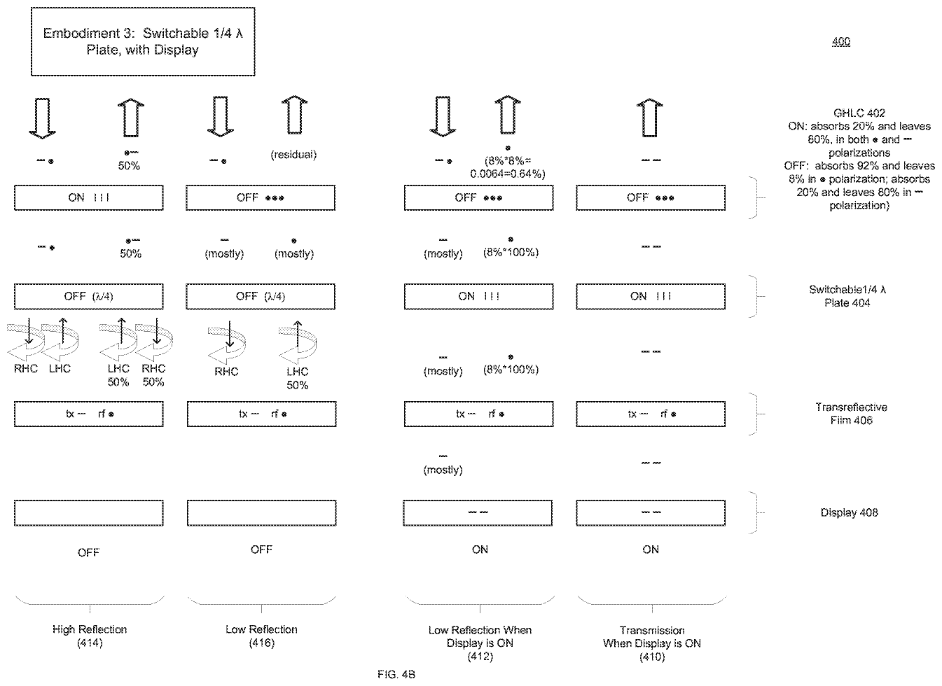

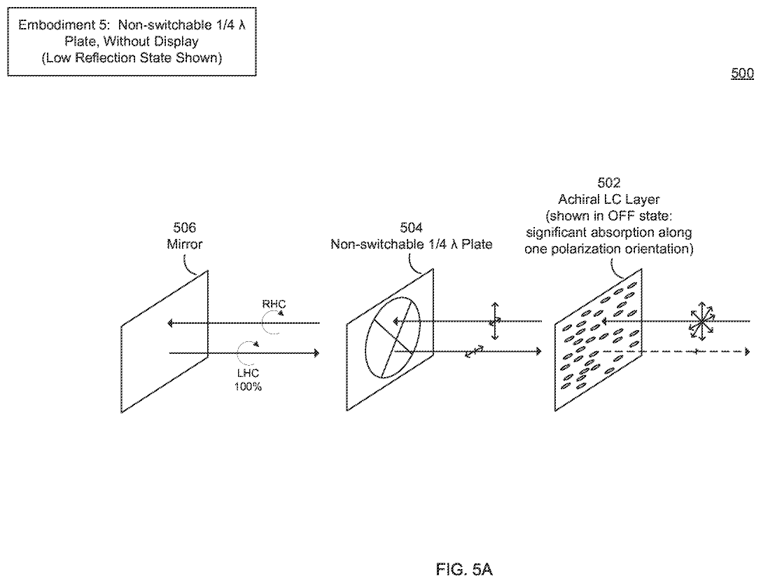

FIG. 4A illustrates a low reflection state of a single-layer non-cholesteric liquid crystal dimmable mirror device 400 including a display, according to some embodiments of the disclosure. The low reflection state shown may be utilized while the associated display device is turn on or turned off. The non-cholesteric liquid crystal may comprise at least one guest-host (GH) liquid crystal layer. According to some embodiments, the at least one GH liquid crystal layer consists of a single GH liquid crystal comprising non-cholesteric liquid crystal molecules. Here, the device 400 comprises a GH liquid crystal layer 402 (shown as an achiral LC layer), a switchable quarter-wave plate 404, a transreflective film 406, and a display 408. The device 400 may be used in an interior or an exterior environment, such as that of a vehicle.

The GH liquid crystal layer 402 may comprise at least one guest host (GH) liquid crystal layer, which may include liquid crystal molecules and dichroic dye molecules. The at least one GH liquid crystal layer is controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in an x-y direction that is (a) parallel to the plane corresponding to the at least one GH liquid crystal layer and (b) configured to substantially absorb a component of light that is linearly polarized along the same x-y direction. The switchable quarter-wave layer 404 is positioned between the transreflective film 406 and the single GH liquid crystal layer 402. In some embodiments, the switchable quarter-wave plate 404 comprises an electronically controlled birefringence (EBC) retarder comprising liquid crystal molecules. As shown, the transreflective film 406 is configured to transmit light in a transmissive polarization orientation and reflect light in a reflective polarization orientation.

FIG. 4B illustrates the operation of such a single-layer non-cholesteric liquid crystal dimmable mirror device 400 including a display, according to some embodiments of the disclosure. Once again, the device 400 comprises a GH liquid crystal layer 402 (shown as an achiral LC layer), a switchable quarter-wave plate 404, a transreflective film 406, and a display 408.

A. Transmission Mode

In a transmission mode (410), the display 408 is on and emits linearly polarized light, shown here in the “--” polarization. The linearly polarized light reaches the transreflective film 406. The transreflective film 406 is positioned such that its transmission axis is shown as “-” and is parallel to the polarization orientation of the linearly polarized light emitted from the display 408. Thus, the linearly polarized light from the display 408 passes through the transreflective film 406. Next, the linearly polarized light reaches the switchable quarter-wave plate 404, which is turned ON in the current mode. Here, when the switchable quarter-wave plate 404 is turned on (electric field applied), its liquid crystal molecules are in the open state and oriented in a vertical orientation that is perpendicular to the plane of the liquid crystal layer. As a result, the linearly polarized light passes through the switchable quarter-wave plate 404. The linearly polarized light next reaches the GH liquid crystal layer 402, which is in the OFF state. When the GH liquid crystal layer 402 is in the off state (no electric field is applied), its liquid crystal molecules are in the closed state and oriented in an orientation that is (a) parallel to the plane of the liquid crystal and (2) indicated by the “●●●” symbol (into the page). In such an orientation, the liquid crystal molecules of the GH liquid crystal layer 402 substantially absorb linearly polarized light oriented along the same “●●●” orientation. The rate of absorption may be adjustable. In some embodiments, the rate of absorption is greater than 50%. In a specific embodiment shown in FIG. 4B, the absorption rate is 92%. That is, the GH layer 402 absorbs 92% of linearly polarize light in the “●●●” orientation and allows 8% of linearly polarize light in the “●●●” orientation to be transmitted through. Thus, the linearly polarize light from the display passes through the device 400 with minimal loss of brightness.

According to some embodiments, low reflection during media transmission (412) is also exhibited. Here, unpolarized light originating from the external environment (e.g., from behind the vehicle) may first reach the GH liquid crystal layer 402. In the current mode, as discussed, the GH liquid crystal layer 402 is in the OFF state (no electric field applied). The liquid crystal molecules of the GH liquid crystal layer 402, positioned in the “●●●” orientation, substantially absorb linearly polarized light oriented along the same “●●●” orientation. In the current example, the absorption rate is 92%. Thus, the GH liquid crystal layer 402 absorbs 92% of the component of the unpolarized light in the “●●●” orientation and allows 8% of the component of the unpolarized light in the “●●●” orientation to pass through. The GH liquid crystal layer 402 leaves the component of the unpolarized light in the “--” orientation mostly unaffected. The result light that leaves the GH liquid crystal layer 402 is mostly linearly polarized along the “--” orientation but also contains 8% of the component of the unpolarized light in the “●●●” orientation. This light reaches the switchable quarter-wave plate 404. The switchable quarter-wave plate 404 is in the ON state, with liquid crystal molecules in the open position, which allows light to pass through regardless of polarization. The resulting light reaches transreflective film 406, which allows linearly polarized light in the “--” orientation to pass through, while reflecting linearly polarized light in the “●●●” orientation. Thus, the transreflective film 406 reflects the 8% of the component of the unpolarized light in the “●●●” orientation. This light then reaches the quarter-wave plate 404 on the return path. The quarter-wave plate 404 is still in the ON state, and it allows light to pass through, regardless of polarization. Thus, the 8% of the component of the unpolarized light in the orientation passes through and reaches the GH liquid crystal layer 402. As discussed, the GH liquid crystal layer 402 is in the OFF state (no electric field applied), with liquid crystal molecules in the “●●●” orientation. The liquid crystal molecules in such an orientation absorb linearly polarized light in the “●●●” orientation according to an absorption rate of 92%, in this example (transmission rate of 8%). Thus, only 8% of the 8% of the component of the original unpolarized light in the “●●●” orientation is allowed to pass through. The resulting reflected light that exits the device 400 is only 8%*8%=0.64% of the component of the original unpolarized light in the “●●●” orientation. In this manner, very low reflection is achieved while the display 408 is on.

B. Reflection Modes

a. High Reflection Mode (414)

A high reflection mode 414 is shown with the display is off. Unpolarized light from the external environment (e.g., from behind the vehicle) may first reach the GH liquid crystal layer 402, which is turned ON. In this state, the liquid crystal molecules of the GH liquid crystal layer 402 are in the open position, which allows light to pass through regardless of polarization. The unpolarized light thus passes through the GH liquid crystal layer 402 and reaches the switchable quarter-wave plate 404. In the current mode, the switchable quarter-wave plate 404 is in the OFF state (electric field not applied) with liquid crystal molecules arranged so as to operate as a quarter-wave plate. The switchable quarter-wave plate 404 converts linearly polarized light in a first x-y orientation (e.g., “--” orientation) into right-handed circularly polarized (RHC) light. The switchable quarter-wave plate 404 converts linearly polarized light in a second x-y orientation (e.g., “●●●” orientation) into left-handed circularly polarized (LHC) light. The RHC light reaches the transreflective film 406, which converts the RHC light to reflected LHC light at a reduced intensity (e.g., 50%). The LHC light reaches the transreflective film 406, which converts the LHC light to reflected RHC light at a reduced intensity (e.g., 50%). Both components of light travel along the return path toward the switchable quarter-wave plate 404. The switchable quarter-wave plate 404 converts the reflected LHC light to linearly polarized light in the “●●●” orientation. The switchable quarter-wave plate 404 converts the reflected RHC light to linearly polarized light in the “--” orientation. The resulting unpolarized light is at a reduced intensity (e.g., 50%), and it passes through the GH liquid crystal layer 402, which is in the open state. Thus, the device 400 operates to provide high reflection in the current mode.

b. Low Reflection Mode (416)

A low reflection mode 416 is also shown with the display is off. Unpolarized light from the external environment (e.g., from behind the vehicle) may first reach the GH liquid crystal layer 402. In the current mode, the GH liquid crystal layer 402 is in the OFF state (no electric field applied). The liquid crystal molecules of the GH liquid crystal layer 402, positioned in the “●●●” orientation, substantially absorb linearly polarized light oriented along the same “●●●” orientation. In the current example, the absorption rate is 92%. Thus, the GH liquid crystal layer 402 absorbs 92% of the component of the unpolarized light in the “●●●” orientation and allows 8% of the component of the unpolarized light in the “●●●” orientation to pass through. The GH liquid crystal layer 402 leaves the component of the unpolarized light in the “--” orientation mostly unaffected. The result light that leaves the GH liquid crystal layer 402 is mostly linearly polarized along the “--” orientation.

In the current mode, the switchable quarter-wave plate 404 is in the OFF state (electric field not applied) with liquid crystal molecules arranged so as to operate as a quarter-wave plate. The switchable quarter-wave plate 404 converts linearly polarized light in a first x-y orientation (e.g., “--” orientation) into right-handed circularly polarized (RHC) light. Thus, the light that is mostly linearly polarized along the “--” orientation is converted to mostly RHC light. The mostly RHC light is reflected by the transreflective film and converted to reflected LHC light at a reduced intensity (e.g., 50%). The reflected LHC light reaches the switchable quarter-wave plate 404 on the return path. The switchable quarter-wave plate 404 converts the reflected LHC light to mostly linearly polarized light along the “●●●” orientation.

The mostly linearly polarized light along the “●●●” orientation reaches the GH liquid crystal layer 402. In the current mode, the switchable quarter-wave plate 404 is in the OFF state (electric field not applied) with liquid crystal molecules arranged so as to operate as a quarter-wave plate. The switchable quarter-wave plate 404 converts linearly polarized light in a first x-y orientation (e.g., “--” orientation) into right-handed circularly polarized (RHC) light. The switchable quarter-wave plate 404 converts linearly polarized light in a second x-y orientation (e.g., “●●●” orientation) into left-handed circularly polarized (LHC) light. The RHC light reaches the transreflective film 406, which converts the RHC light to reflected LHC light at a reduced intensity (e.g., 50%). The LHC light reaches the transreflective film 406, which converts the LHC light to reflected RHC light at a reduced intensity (e.g., 50%). Both components of light travel along the return path toward the switchable quarter-wave plate 404. The switchable quarter-wave plate 404 converts the reflected LHC light to linearly polarized light in the “●●●” orientation. The switchable quarter-wave plate 404 converts the reflected RHC light to linearly polarized light in the “--” orientation. The resulting unpolarized light is at a reduced intensity (e.g., 50%), and it passes through the GH liquid crystal layer 402. The GH liquid crystal layer 402 is in the OFF state (no electric field applied), with liquid crystal molecules in the “●●●” orientation. The liquid crystal molecules in such an orientation absorb linearly polarized light in the “●●●” orientation according to an absorption rate of 92%, in this example (transmission rate of 8%). Thus, the residual light that exits the GH liquid crystal layer 402 is substantially attenuated.

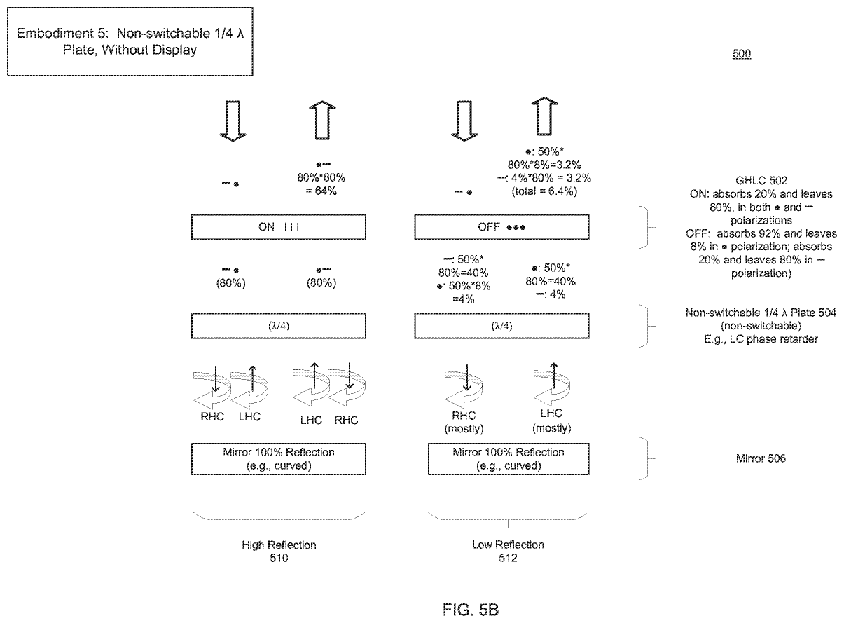

Note that in FIG. 4B, some details are not presented above relating to less dominant attenuation effects of liquid crystal molecules (e.g., while in the open state with LC molecules in a vertical orientation relative to the plane of the LC layer). Some of these details are discussed more thoroughly in the context of FIG. 5B, below.

IV. LC Layer and Quarter-Wave Plate, Without Display

FIG. 5A illustrates a low reflection state of a single-layer non-cholesteric liquid crystal dimmable mirror device 500 without a display, according to some embodiments of the disclosure. The non-cholesteric liquid crystal may comprise at least one guest-host (GH) liquid crystal layer. According to some embodiments, the at least one GH liquid crystal layer consists of a single GH liquid crystal comprising non-cholesteric liquid crystal molecules. Here, the device 500 comprises a GH liquid crystal layer 502 (shown as an achiral LC layer), a non-switchable quarter-wave plate 504, and a mirror 506. In one embodiment, the device 500 comprises:
at least one guest host (GH) liquid crystal layer 502 comprising liquid crystal molecules and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in an x-y direction that is (a) parallel to the plane corresponding to the at least one GH liquid crystal layer and (b) configured to substantially absorb a component of light that is linearly polarized along the same x-y direction
a non-switchable quarter-wave layer 504. In some embodiments, the non-switchable quarter-wave plate comprises a film made of a polymer material and configured to retard the phase of light along a first x-y orientation by 90 degrees, relative to the phase of light along a second x-y orientation perpendicular to the first x-y orientation.
a reflective layer (e.g., mirror 506)

FIG. 5B illustrates the operation of such a single-layer non-cholesteric liquid crystal dimmable mirror device 500 without a display and a non-switchable quarter-wave plate, according to some embodiments of the disclosure. Once again, the device 500 comprises a GH liquid crystal layer 502, a non-switchable quarter-wave plate 504, and a mirror 506. The mirror 506 may be a flat mirror or a curved mirror. The curvature of the mirror may be along one axis (e.g., x-axis) or along two axes (e.g., x-axis and y-axis). The mirror may be a spherically shaped mirror. The device 500 may be used in an interior or an exterior environment, such as that of a vehicle.

A. High Reflection Mode (510)

A high reflection mode 510 is shown. Unpolarized light from the external environment (e.g., from behind the vehicle) may first reach the GH liquid crystal layer 502, which is turned ON. In this state, the liquid crystal molecules of the GH liquid crystal layer 502 are in the open position, which allows light to pass through regardless of polarization. The passage of light through liquid crystal molecules in the open position may occur with some degree of attenuation (which was not mentioned previously in the context of FIG. 4B). As shown in the present figure, such attenuation rate may be, for example, 80%. That is 20% of the light is absorbed, and 80% of the light is allowed to pass through. The attenuated unpolarized light (80%) thus passes through the GH liquid crystal layer 502 and reaches the non-switchable quarter-wave plate 504. The non-switchable quarter-wave plate 504 converts linearly polarized light in a first x-y orientation (e.g., “--” orientation) into right-handed circularly polarized (RHC) light. The non-switchable quarter-wave plate 504 converts linearly polarized light in a second x-y orientation (e.g., “●●●” orientation) into left-handed circularly polarized (LHC) light. The RHC light reaches the mirror 506, which converts the RHC light to reflected LHC light. The LHC light reaches the mirror 506, which converts the LHC light to reflected RHC light. Both components of light travel along the return path toward the non-switchable quarter-wave plate 504. The non-switchable quarter-wave plate 504 converts the reflected LHC light to linearly polarized light in the “●●●” orientation. The non-switchable quarter-wave plate 504 converts the reflected RHC light to linearly polarized light in the “--” orientation. The resulting unpolarized light is at a reduced intensity (e.g., 80%), and it passes through the GH liquid crystal layer 502, which is in the open state. The GH liquid crystal layer 502 further attenuates the unpolarized light by another 80%. This results in unpolarized light that exists the layered structure at 80%*80%=64% intensity. The device 500 thus operates to provide high reflection in the current mode.

B. Low Reflection Mode (512)

A low reflection mode 512 is also shown. Unpolarized light from the external environment (e.g., from behind the vehicle) may first reach the GH liquid crystal layer 502. In the current mode, the GH liquid crystal layer 402 is in the OFF state (no electric field applied). The liquid crystal molecules of the GH liquid crystal layer 502, positioned in the “●●●” orientation, substantially absorb linearly polarized light oriented along the same “●●●” orientation. In the current example, the absorption rate is 92%. Thus, the GH liquid crystal layer 402 absorbs 92% of the component of the unpolarized light in the “●●●” orientation and allows 8% of the component of the unpolarized light in the “●●●” orientation to pass through. The GH liquid crystal layer 502 leaves the component of the unpolarized light in the “--” orientation mostly unaffected. However, some absorption can still occur. Just as an example, the GH liquid crystal layer 502 may absorb 20% of the component of the unpolarized light in the “--” orientation and allow 80% of the component of the unpolarized light in the “--” orientation to pass through. The resulting light that leaves the GH liquid crystal layer 402 has a polarized component along the “●●●” orientation with a reduced intensity of 50%*8%=4%. The resulting light that leaves the GH liquid crystal layer 402 has a polarized component along the “--” orientation with a reduced intensity of 50%*80%=40%. This resulting light then reaches the non-switchable quarter-wave plate 504. The switchable quarter-wave plate 504 converts linearly polarized light in a first x-y orientation (e.g., “--” orientation) into right-handed circularly polarized (RHC) light. Thus, the light that is mostly linearly polarized along the “--” orientation is converted to mostly RHC light. The mostly RHC light is reflected by the mirror 506 and converted to reflected LHC light. The reflected LHC light reaches the non-switchable quarter-wave plate 504 on the return path. The non-switchable quarter-wave plate 504 converts the reflected LHC light to mostly linearly polarized light along the “●●●” orientation. In the present example, this reflected, mostly linearly polarized light has a polarized component along the “●●●” orientation with a reduced intensity of 50%*80%=40%, as well as a polarized component along the “--” orientation with a reduced intensity of 50%*8%=4%. The light reaches the GH liquid crystal layer 502. Again, the liquid crystal molecules of the GH liquid crystal layer 502, positioned in the “●●●” orientation, substantially absorb linearly polarized light oriented along the same orientation. The polarized light along the “●●●” orientation is thus further attenuated according to an attenuation rate of 8%. The polarized light along the “--” orientation is thus further attenuated according to an attenuation rate of 80%. Thus, the reflected light that exits the GH liquid crystal layer 502 has a polarized component along the “●●●” orientation with a reduced intensity of 50%*80%*8%=3.2%, as well as a polarized component along the “--” orientation with a reduced intensity of 4%*80%=3.2%. The total intensity of the resulting combined unpolarized light is thus 3.2%+3.2%=6.4% of the intensity of the unpolarized light that originally entered the device 500 from the external environment.

V. Double Layer Non-Cholesteric LC, without Display

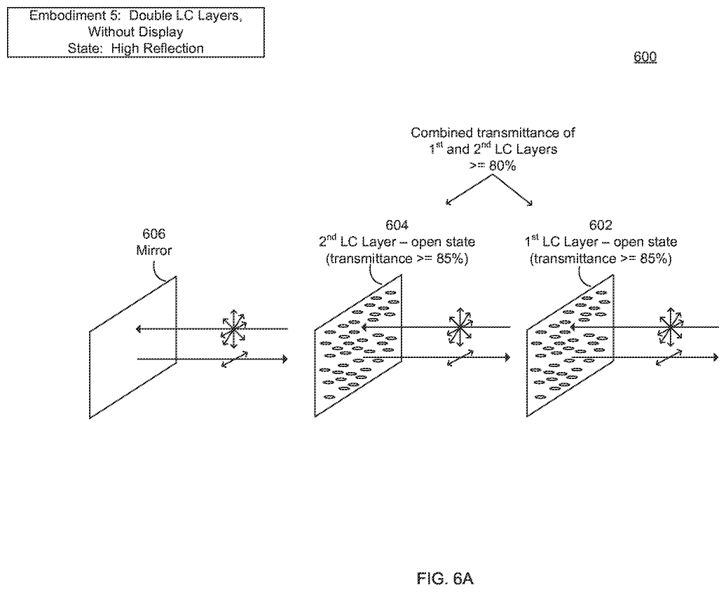

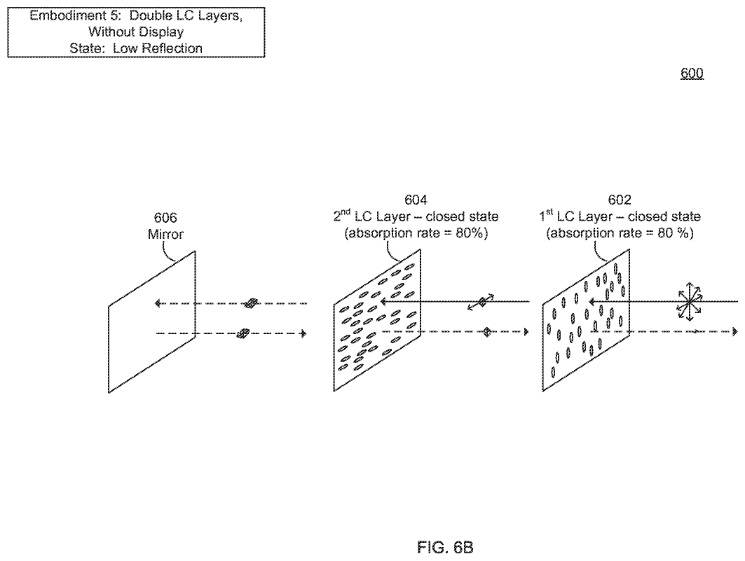

FIG. 6A illustrates a high reflection state of a double-layer non-cholesteric liquid crystal dimmable mirror device 600 without a display, according to some embodiments of the disclosure. Here, the at least one GH liquid crystal layer comprises two GH liquid crystal layers. Each GH liquid crystal layer may comprise non-cholesteric liquid crystal molecules. As shown, the device 600 comprises a first GH liquid crystal layer 602, a second GH liquid crystal layer 604, and a mirror 606. In one embodiment, the device 600 comprises:
a first guest host (GH) liquid crystal layer 602 comprising liquid crystal molecules and dichroic dye molecules
a second GH liquid crystal layer 604 positioned between the reflective layer and the first GH liquid crystal layer, the second GH liquid crystal layer comprising liquid crystal molecules and dichroic dye molecules
   each of the first and second GH liquid crystal layers may be controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer
   in a first reflection mode, the layered structure may be configured to reflect light originating from a first side of the layered structure back toward the first side of the layered structure, corresponding to a first reflectivity rate
   in a second reflection mode, the layered structure may be configured to reflect light originating from the first side of the layered structure back toward the first side of the layered structure, corresponding to a second reflectivity rate less than the first reflectivity rate
a reflective layer 606

A. High Reflection Mode (e.g., FIG. 6A)

As shown in FIG. 6A, the long axis of dichroic dye liquid crystal is perpendicular to the plane of the substrate, the light occurs weak absorption, at this time the liquid crystal layer transmittance ≥80%, and through the liquid crystal layer of light for non-linear polarized light. The mirror may reflect the light back on a return path through the double LC layers again. The rearview mirror can be highly transparent and provide a clear view of the image behind the vehicle.

B. Low Reflection Mode (e.g., FIG. 6B):

FIG. 6B illustrates a low reflection state of the double-layer non-cholesteric liquid crystal dimmable mirror device 600 without a display, according to some embodiments of the disclosure. For example, when there is strong light behind the vehicle, a light intensity sensor (not shown) may signal feedback to the driver circuit (not shown). The driver circuit may rapidly respond by generating an appropriate voltage across conductor layers (not shown) that sandwich the first GH liquid crystal layer 602 and the second GH liquid crystal layer 604. According to some embodiments, in this low reflection mode, the non-cholesteric liquid crystal molecules are driven to a nematic phase, in which the long axes of the liquid crystal molecules are parallel to the plane of the liquid crystal layers. Within the plane of the liquid crystal layers, orientation of the liquid crystal molecules of the first liquid crystal layer 602 and the orientation of the liquid crystal molecules of the second liquid crystal layer 604 are perpendicular to each other. Here, the light transmission rate is lower than the low reflection mode of FIG. 2D. The light through the liquid crystal layers is linearly polarized light. The polarization direction of the linearly polarized light is perpendicular to the long axis of the liquid crystal molecules of the second liquid crystal layer. In at least one embodiment, only the relative linear polarization directions of the two LC layers are important.

For example, light traveling from the rear of the vehicle (e.g., from the right side of FIG. 6B) may be unpolarized light. In the low reflection mode, the liquid crystal molecules of the first liquid crystal layer 602 have been driven such that their long axes are parallel to the plane of the first liquid crystal layer 602 and vertical within the plane of the first liquid crystal layer 602. The vertically oriented liquid crystal molecules significantly absorb vertically polarized (linearly polarized in the vertical orientation) light. The resulting light is thus mostly horizontally polarized (linearly polarized in the horizontal orientation). Because absorption of the vertically polarized light is not perfect, there is residual vertically polarized light as well. The resulting light then passes through the second liquid crystal layer 604. In the low reflection mode, the liquid crystal molecules of the second liquid crystal layer 604 have been driven such that their long axes are parallel to the plane of the second liquid crystal layer 604 and horizontal within the plane of the second liquid crystal layer 604. The horizontally oriented liquid crystal molecules significantly absorb horizontally polarized (linearly polarized in the horizontal orientation) light. The resulting light, which now has passed through both the first liquid crystal layer 602 and the second liquid crystal layer 604, is significantly attenuated in both the vertical polarization orientation and the horizontal polarization orientation. Because absorption of the horizontally polarized light is not perfect, either there is also residual horizontally polarized light. The light that pass through both the first and the second liquid crystal layers now encounters the reflective layer (e.g., mirror 606) and is reflected. On the reflection path (return path), the light now passes through the second liquid crystal layer 604 again (in the reverse direction). The horizontally oriented liquid crystal molecules further absorb the already-attenuated horizontally polarized light in the reflected light. The resulting light then passes through the first liquid crystal layer 602 again (in the reverse direction). The vertically oriented liquid crystal molecules of the first liquid crystal layer 602 further absorb much of the remaining vertically oriented polarized light in the reflected light. The resulting light then travels, as the final reflected light, toward the rear of the vehicle (toward the right side of FIG. 6B) in this example.

VI. Drive Circuitry

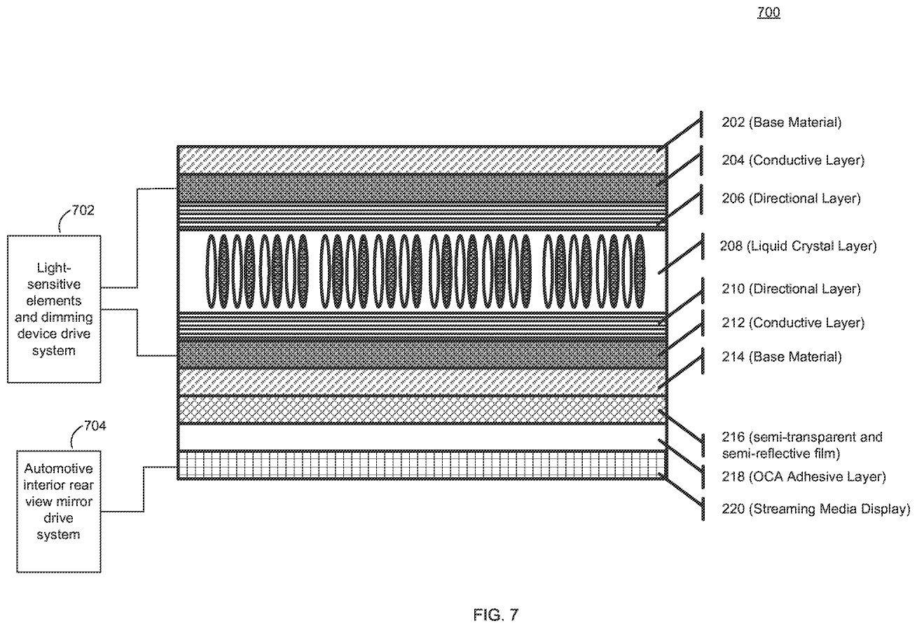

FIG. 7 shows a drive circuitry system 700 for providing driving signals for components of devices described previously. As shown, the drive circuitry 700 comprises one or more light-sensitive elements and dimming device drive system 702. Various states shown in FIGS. 2A-6B may be driven by a light-sensitive element, such as one or more photodiodes. Such sensor input may indicate the presence of light at or above a threshold level, to trigger operation of, for example, a low reflection mode. Components, such as various liquid crystal layers, may be driven by such sensor input signal or drive signals derived therefrom. Drive circuitry 700 may also comprise one or more media sources such as an automotive interior rearview mirror drive system 704. Various display devices illustrated in FIGS. 2A-6B may be driven by media sources. For example, such media sources comprise one or more cameras or components providing media content aboard a vehicle.

Just as an example, the dimmable mirror apparatus 200 previously described with respect to FIG. 2A is shown for illustrative purposes. The dimmable mirror apparatus 200 comprises the first base (substrate) material layer 202, the first conductive layer 204, the first directional layer 206, the liquid crystal (LC) layer 208, the directional layer 210, the second conductive layer 212, the second base (substrate) material layer 214, the transreflective film layer 216, the OCA adhesive layer 218, and the display 220. The drive circuitry system 700 may provide signals various components of the dimmable mirror apparatus 200. For instance, the light-sensitive element and dimming device drive system 702 may be connected to the conductive layers 204 and 212 of the dimming device.

In one embodiment, the light-sensitive elements comprise a first light-sensitive element and a second light-sensitive element. The first light-sensitive element may be positioned toward the front of the car, to sense whether the environment outside the vehicle is day or night. When the sensed environment is day, the dimming device may be placed in a non-triggered, or non-working state. When the sensed environment for night, the dimming device can be triggered and placed in a working state and operated according to more specific measurements obtained by the second light-sensitive element. The second light-sensitive element may be positioned towards the rear of the vehicle, to detect the existence of glare from the rear side of the vehicle. When the light-sensitive element detects glare from the rear of the vehicle, the dimming device drive system 700 may provide corresponding signal feedback to effectuate a corresponding intensity of an electric field (e.g., providing a corresponding voltage to the conductive layers 204 and 212) to drive the liquid crystal layer (e.g., liquid crystal layer 208) to achieve the transmission rate and reflectivity adjustment.

In one embodiment, the dimming device drive system 700 is electrically coupled to the interior and/or exterior rearview dimmable mirror, to control a level of dimming in response to sensed light intensity. In one embodiment, the dimming device drive system 700 is electrically coupled to the interior and/or exterior rearview dimmable mirror, to drive the streaming media display. While the dimmable mirror apparatus 200 is shown here, the drive circuitry system 700 may provide signals to other embodiments of dimmable mirror devices, such as those including a display, not including a display, those utilizing linearly polarized light, circularly polarized light, and other variations.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device or system is capable of manipulating or transforming signals, typically represented as physical electronic, electrical, or magnetic quantities within memories, registers, or other information storage devices, transmission devices, or display devices of the special purpose computer or similar special purpose electronic computing device or system.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure as defined by the appended claims. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. An apparatus having a layered structure comprising:
a transreflective layer configured to transmit light in a transmissive polarization orientation and reflect light in a reflective polarization orientation;
at least one guest host (GH) liquid crystal layer comprising non-cholesteric liquid crystal molecules having a non-helical structure and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer; and
a switchable quarter-wave layer positioned between the transreflective layer and the at least one GH liquid crystal layer, the switchable quarter-wave layer comprising an electronically controlled birefringence (ECB) retarder comprising liquid crystal molecules,
wherein in a transmission mode, the layered structure is configured to transmit linearly polarized light originating from a first side of the layered structure through the layered structure to a second side of the layered structure, corresponding to a transmittance rate,
wherein in a first reflection mode, the layered structure is configured to reflect light originating from the second side of the layered structure back toward the second side of the layered structure, corresponding to a first reflectivity rate, and
wherein in a second reflection mode, the layered structure is configured to reflect light originating from the second side of the layered structure back toward the second side of the layered structure, corresponding to a second reflectivity rate less than the first reflectivity rate.

2. An apparatus having a layered structure comprising:
a transreflective layer configured to transmit light in a transmissive polarization orientation and reflect light in a reflective polarization orientation; and
at least one guest host (GH) liquid crystal layer comprising liquid crystal molecules and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer,
wherein in a transmission mode, the layered structure is configured to transmit linearly polarized light originating from a first side of the layered structure through the layered structure to a second side of the layered structure, corresponding to a transmittance rate,
wherein in a first reflection mode, the layered structure is configured to reflect light originating from the second side of the layered structure back toward the second side of the layered structure, corresponding to a first reflectivity rate, and
wherein in a second reflection mode, the layered structure is configured to reflect light originating from the second side of the layered structure back toward the second side of the layered structure, corresponding to a second reflectivity rate less than the first reflectivity rate.

3. The apparatus of claim 2, wherein the at least one GH liquid crystal layer consists of a single GH liquid crystal layer.

4. The apparatus of claim 3, wherein the single GH liquid crystal layer comprises cholesteric liquid crystal molecules having a helical structure.

5. The apparatus of claim 4, wherein in the second reflection mode:
the cholesteric liquid crystal molecules of the single GH liquid crystal layer are configured to absorb a portion of unpolarized light originating from the second side of the layered structure to generate attenuated, unpolarized light;
the transreflective layer is configured to reflect a portion of the attenuated, unpolarized light, to generate reflected, attenuated, polarized light in the reflective polarization orientation; and
the cholesteric liquid crystal molecules of the single GH liquid crystal layer are configured to absorb a portion of the reflected, attenuated, polarized light, to generate resultant reflected light directed toward the second side of the layered structure.

6. The apparatus of claim 3, wherein the single GH liquid crystal layer comprises non-cholesteric liquid crystal molecules having a non-helical structure.

7. The apparatus of claim 6, wherein the layered structure further comprises a quarter-wave layer positioned between the transreflective layer and the single GH liquid crystal layer.

8. The apparatus of claim 7, wherein in the second reflection mode:
the non-cholesteric liquid crystal molecules of the single GH liquid crystal layer are configured to selectively absorb light originating from the second side of the layered structure, to generate attenuated light primarily polarized in a first linear polarization orientation;
the quarter-wave layer is configured to convert the attenuated light to circularly polarized light;
the transreflective layer is configured to reflect a portion of the circularly polarized light, to generate reflected, circularly polarized light;
the quarter-wave layer is configured to convert the reflected, circularly polarized light to generate reflected, attenuated light primarily polarized in a second linear polarization orientation perpendicular to the first linear polarization orientation; and
the non-cholesteric liquid crystal molecules of the single GH liquid crystal layer are configured to further absorb a portion of the reflected, attenuated light, to generate resultant reflected light directed toward the second side of the layered structure.

9. The apparatus of claim 7, wherein the quarter-wave layer comprises a switchable quarter-wave plate.

10. The apparatus of claim 9, wherein the switchable quarter-wave plate comprises an electronically controlled birefringence (ECB) retarder comprising liquid crystal molecules.

11. The apparatus of claim 2, wherein the at least one GH liquid crystal layer comprises a first GH liquid crystal layer and a second GH liquid crystal layer.

12. The apparatus of claim 11, wherein each of the first GH liquid crystal layer and the second GH liquid crystal layer comprises non-cholesteric liquid crystal molecules.

13. The apparatus of claim 12, wherein in the second reflection mode:
the non-cholesteric liquid crystal molecules of the first GH liquid crystal layer are configured to attenuate light originating from the second side of the layered structure, by absorbing light in a first linear polarization orientation, to generate first attenuated light having reduced intensity in the first linear polarization orientation;
the non-cholesteric liquid crystal molecules of the second GH liquid crystal layer are configured to further attenuate the first attenuated light, by absorbing light in a second linear polarization orientation, to generate second attenuated light having reduced intensity in both the first and the second linear polarization orientations;
the transreflective layer is configured to reflect a portion of the second attenuated light, to generate reflected, attenuated, polarized light in the reflective polarization orientation;
the non-cholesteric liquid crystal molecules of the second GH liquid crystal layer are configured to further attenuate the reflected, attenuated, polarized light, by absorbing light in the second linear polarization orientation, to generate third attenuated light having further reduced intensity in the second linear polarization orientation; and
the non-cholesteric liquid crystal molecules of the first GH liquid crystal layer are configured to further attenuate the third attenuated light, by absorbing light in the first linear polarization orientation, to generate fourth attenuated light having further reduced intensity in both the first and the second linear polarization orientations, as resultant reflected light directed toward the second side of the layered structure.

14. The apparatus of claim 2, wherein the transmittance rate is at least 80%, the first reflectivity rate is at least 40%, and the second reflectivity rate is less than 20%.

15. The apparatus of claim 2, wherein the at least one GH liquid crystal layer is configured to be driven to (1) the first reflection mode by a first signal level associated with a light sensitive element and (2) the second reflection mode by a second signal level associated with the light sensitive element.

16. The apparatus of claim 2, further comprising a display panel coupled to the layered structure and configured to generate images comprising polarized light from the first side of the layered structure.

17. An apparatus having a layered structure comprising:
a reflective layer;
at least one guest host (GH) liquid crystal layer comprising liquid crystal molecules and dichroic dye molecules, each of the at least one GH liquid crystal layer controllable to operate in at least two possible states including (1) a vertical state in which the liquid crystal molecules are oriented in a direction perpendicular to a plane corresponding to the at least one GH liquid crystal layer and (2) a planar state in which the liquid crystal molecules are oriented in a direction parallel to the plane corresponding to the at least one GH liquid crystal layer; and
a quarter-wave layer positioned between the reflective layer and the at least one GH liquid crystal layer,
wherein in a first reflection mode, the layered structure is configured to reflect light originating from a first side of the layered structure back toward the first side of the layered structure, corresponding to a first reflectivity rate, and
wherein in a second reflection mode, the layered structure is configured to reflect light originating from the first side of the layered structure back toward the first side of the layered structure, corresponding to a second reflectivity rate less than the first reflectivity rate.

18. The apparatus of claim 17, wherein the reflective layer comprise a mirror.

19. The apparatus of claim 17, wherein the at least one GH liquid crystal layer comprises non-cholesteric liquid crystal molecules having a non-helical structure.

20. The apparatus of claim 19, wherein in the second reflection mode:
the non-cholesteric liquid crystal molecules of the at least one GH liquid crystal layer are configured to selectively absorb light originating from the first side of the layered structure, to generate attenuated light primarily polarized in a first linear polarization orientation;
the quarter-wave layer is configured to convert the attenuated light to circularly polarized light;
the reflective layer is configured to reflect a portion of the circularly polarized light, to generate reflected, circularly polarized light;
the quarter-wave layer is configured to convert the reflected, circularly polarized light to generate reflected, attenuated light primarily polarized in a second linear polarization orientation perpendicular to the first linear polarization orientation; and
the non-cholesteric liquid crystal molecules of the at least one GH liquid crystal layer are configured to further absorb a portion of the reflected, attenuated light, to generate resultant reflected light directed toward the first side of the layered structure.

21. The apparatus of claim 17, wherein the quarter-wave layer comprises a non-switchable quarter-wave plate.

22. The apparatus of claim 17, wherein the first reflectivity rate is at least 40%, and the second reflectivity rate is less than 20%.

23. The apparatus of claim 17, wherein the at least one GH liquid crystal layer is configured to be driven to (1) the first reflection mode by a first signal level associated with a light sensitive element and (2) the second reflection mode by a second signal level associated with the light sensitive element.

24. An apparatus having a layered structure comprising:
a reflective layer;
a first guest host (GH) liquid crystal layer comprising liquid crystal molecules and dichroic dye molecules; and
a second GH liquid crystal layer positioned between the reflective layer and the first GH liquid crystal layer, the second GH liquid crystal layer comprising liquid crystal molecules and dichroic dye molecules,
wherein each of the first and second GH liquid crystal layers is controllable to operate in at least two possible states including (1) a vertical state in which the liquid crystal molecules are oriented in a direction perpendicular to a plane corresponding to the first or second GH liquid crystal layer and (2) a planar state in which the liquid crystal molecules are oriented in a direction parallel to the plane corresponding to the first or second GH liquid crystal layer, and
wherein in a first reflection mode, the layered structure is configured to reflect light originating from a first side of the layered structure back toward the first side of the layered structure, corresponding to a first reflectivity rate, and
wherein in a second reflection mode, the layered structure is configured to reflect light originating from the first side of the layered structure back toward the first side of the layered structure, corresponding to a second reflectivity rate less than the first reflectivity rate.

25. The apparatus of claim 24, wherein the reflective layer comprise a mirror.

26. The apparatus of claim 24, wherein each of the first GH liquid crystal layer and the second GH liquid crystal layer comprises non-cholesteric liquid crystal molecules.

27. The apparatus of claim 26, wherein in the second reflection mode:
the non-cholesteric liquid crystal molecules of the first GH liquid crystal layer are configured to attenuate light originating from the first side of the layered structure, by absorbing light in a first linear polarization orientation, to generate first attenuated light having reduced intensity in the first linear polarization orientation;
the non-cholesteric liquid crystal molecules of the second GH liquid crystal layer are configured to further attenuate the first attenuated light, by absorbing light in a second linear polarization orientation, to generate second attenuated light having reduced intensity in both the first and the second linear polarization orientations;
the reflective layer is configured to reflect the second attenuated light, to generate reflected, attenuated light;
the non-cholesteric liquid crystal molecules of the second GH liquid crystal layer are configured to further attenuate the reflected, attenuated light, by absorbing light in the second linear polarization orientation, to generate third attenuated light having further reduced intensity in the second linear polarization orientation; and
the non-cholesteric liquid crystal molecules of the first GH liquid crystal layer are configured to further attenuate the third attenuated light, by absorbing light in the first linear polarization orientation, to generate fourth attenuated light having further reduced intensity in both the first and the second linear polarization orientations, as resultant reflected light directed toward the first side of the layered structure.

28. The apparatus of claim 24, wherein the first reflectivity rate is at least 40%, and the second reflectivity rate is less than 20%.

29. The apparatus of claim 24, wherein each of the first and second GH liquid crystal layers is configured to be driven to (1) the first reflection mode by a first signal level associated with a light sensitive element and (2) the second reflection mode by a second signal level associated with the light sensitive element.
